(19) United States
(12) Patent Application Publication
(10) Pub. No.: US 2011/0066983 A1
(43) Pub. Date: Mar. 17, 2011

(54) ELECTRONIC DEVICE AND METHOD FOR PROVIDING SHORTCUT INTERFACE

(75) Inventor: Sung Kyu KIM, Hwaseong-si (KR)

(73) Assignee: Samsung Electronics Co., Ltd., Suwon-si (KR)

(21) Appl. No.: 12/882,382

(22) Filed: Sep. 15, 2010

(30) Foreign Application Priority Data
Sep. 15, 2009 (KR) 10-2009-0086890

(51) Int. Cl. G06F 3/048

(52) U.S. Cl. 715/835

(57) ABSTRACT

Disclosed is an electronic device and method for providing a shortcut interface. In the method, a control unit of the device allots a shortcut key to a shortcut target item among items displayed in a display region, depending on shortcut target item information used to distinguish the shortcut target item in the items. Then the control unit displays the shortcut key in the display region. When the shortcut key is selected, the control unit performs a particular function of the shortcut target item to which the selected shortcut key is allotted.

### PRIORITY

This application claims priority under 35 U.S.C. §119(a) to an application filed in the Korean Intellectual Property Office on Sep. 15, 2009, and assigned Serial No. 10-2009-0086890, the contents of which are incorporated herein by reference.

### BACKGROUND OF THE INVENTION

1. Field of the Invention

The present invention relates to an electronic device and method for providing a shortcut interface.

2. Description of the Related Art

Typically, an electronic device such as a mobile phone or a personal computer offers a shortcut interface. When a user selects a predefined shortcut key, an electronic device recognizes a user's selection input, and then performs a particular function assigned to a selected shortcut key.

A conventional shortcut interface is typically based on a static one-to-one allotment between a shortcut key and a specific application or function. For example, in most of word processing programs, ‘Save file’ and ‘Save as different name’ are respectively assigned to ‘Ctrl+S’ and ‘Ctrl+A’. So, when a shortcut key ‘Ctrl+S’ is selected, a function to save a file is therefore performed.

Unfortunately, such a static allotment style may often be inefficient. For example, in a case where a web browser or news reader adopts a static shortcut key allotment style, it may be difficult to provide a convenient shortcut interface in response to variations in content or items displayed on a screen.

### BRIEF SUMMARY OF THE INVENTION

Accordingly, the present invention has been made to address the above-mentioned problems and/or disadvantages and to offer at least the advantages described below.

An aspect of the present invention is to provide an optimal shortcut interface which is well adapted to variations in content or items displayed on a screen of an electronic device.

According to one aspect of the present invention, a method for providing a shortcut interface includes allotting a shortcut key to a shortcut target item among items displayed in a display region, depending on shortcut target item information used to distinguish the shortcut target item in the items; displaying the shortcut key in the display region; and when the shortcut key is selected, performing a particular function of the shortcut target item to which the selected shortcut key is allotted.

According to another aspect of the present invention, an electronic device for providing a shortcut interface includes a display unit configured to display items in a display region; an input unit configured to receive a selection of a shortcut key; and a control unit configured to allot the shortcut key to a shortcut target item among the items displayed in the display region, depending on shortcut target item information used to distinguish the shortcut target item in the items, and when the shortcut key is selected through the input unit, to perform a particular function of the shortcut target item to which the selected shortcut key is allotted.

### BRIEF DESCRIPTION OF THE DRAWINGS

Other aspects, advantages, and salient features of the invention will become apparent to those skilled in the art from the following detailed description, which, taken in conjunction with the annexed drawings, discloses exemplary embodiments of the invention.

FIG. 1 is a block diagram illustrating an electronic device for providing a shortcut interface in accordance with an embodiment of the present invention;

FIG. 2 is a view illustrating variations in a screen view on a display unit of an electronic device in accordance with an embodiment of the present invention;

FIG. 3 is a view illustrating a screen view on a display unit of an electronic device in accordance with another embodiment of the present invention;

FIG. 4 is a view illustrating a screen view of a mobile web browser in accordance with still another embodiment of the present invention;

FIG. 5 is a flow chart illustrating a method for providing a shortcut interface in an electronic device in accordance with an embodiment of the present invention;

FIG. 6 is a flow chart illustrating a method for providing a shortcut interface in an electronic device in accordance with another embodiment of the present invention;

FIG. 7 is a flow chart illustrating a method for providing a shortcut interface in an electronic device in accordance with still another embodiment of the present invention;

FIG. 8 is a flow chart illustrating in detail a step of retrieving shortcut target items for a shortcut interface in accordance with an embodiment of the present invention;

FIG. 9 is a flow chart illustrating in detail a step of allotting a shortcut key to a retrieved item in accordance with an embodiment of the present invention; and

FIG. 10 is a flow chart illustrating in detail a step of allotting a shortcut key to a retrieved item in accordance with another embodiment of the present invention.

### DETAILED DESCRIPTION OF EMBODIMENTS OF THE PRESENT INVENTION

Exemplary, non-limiting embodiments of the present invention will now be described more fully with reference to the accompanying drawings. This invention may, however, be embodied in many different forms and should not be construed as limited to the embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent certain embodiments of the invention, the drawings are not necessarily to scale and certain features may be exaggerated or omitted in order to better illustrate and explain the present invention.

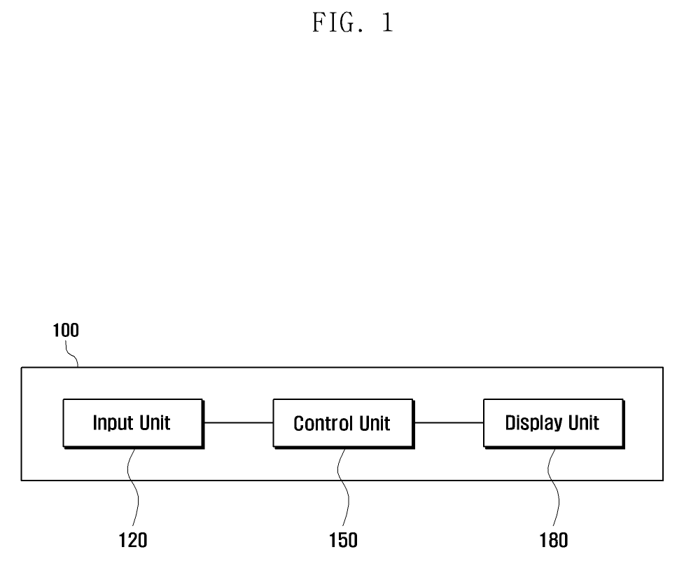

FIG. 1 is a block diagram illustrating an electronic device for providing a shortcut interface in accordance with an embodiment of the present invention.

Referring to FIG. 1, the electronic device 100 which provides a shortcut interface includes, but is not limited to, an input unit 120, a control unit 150, and a display unit 180.

The display unit 180 displays one or more items on a display region thereof, and will be described further hereinbelow.

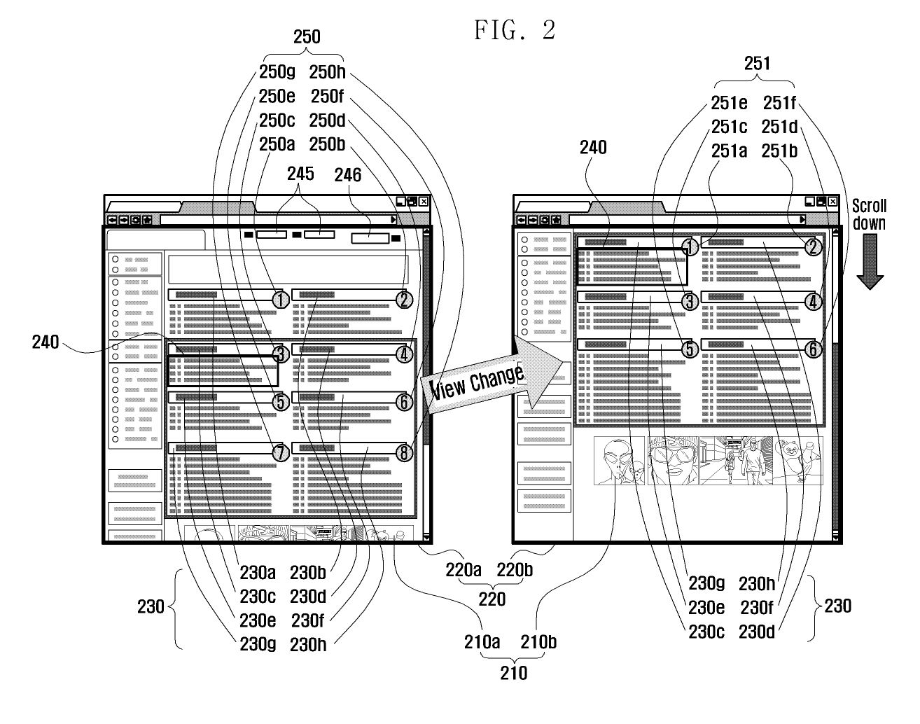

FIG. 2 is a view illustrating variations in a screen view on a display unit of an electronic device in accordance with an embodiment of the present invention.

FIG. 2 shows a web browser, in which the first screen view 210a is changed to the second screen view 210b, depending on a user's gesture for scrolling.

A display region 220 is contained in screen view 210. In FIG. 2, the display region 220 is represented as a rectangular region enclosed by a thick line.

In this disclosure, the display region 220 is defined as a changeably displayed part of the screen view 210 rather than the entire screen view 210. Namely, a view of the display region 220 can be changed in response to a user's scrolling operation or link selection. One or more items 230, 240, 245 and 246 may be arranged and displayed in the display region 220. A user, administrator, device manufacturer or software distributor may determine or modify the size, shape or location of the display region 220.

Content refers to something displayed in the display unit 220, following a markup language format such as HTML (Hyper Text Markup Language) or XML (eXtensible Markup Language). Such content may, however, be represented in any other suitable format which allows the arrangement of items such as links, images and input boxes.

An item refers to a variety of objects, such as links, buttons, text areas, images and videos, allowing a user's operation. In the case of content written in HTML format, an item may refer to an object expressed by the “a” tag (which means a link), the “input” tag (which means a text input box, a button, a checkbox, etc.), the “javascript” tag (which means JavaScript), the “img” tag (which means an image), or the like.

A shortcut target item refers to a particular item to which a shortcut key is assigned. A shortcut target item may be represented by means of a tag, for example, or any other equivalent form in the content.

The following is an example of an element written in HTML format and composed of a tag and an item for content to be rendered on the display region.

<a href=“http://www.samsung.com/”>samsung1</a>

This tag creates a link to “http://www.samsung.com”. Here, if this tag has the “is Shortcut” attribute, the “y” value indicates that an item to be rendered is a shortcut target item, and the “n” value indicates that an item to be rendered is not a shortcut target item.

<a href=“http://www.samsung.com/” isShortcut=“y”>samsung2</a>
<a href=“http://www.samsung.com/” isShortcut=“n”>samsung3</a>

Namely, when the control unit 150 reads two items “samsung2” and “samsung3” in the content, it interprets “samsung2” as a shortcut target item but considers “samsung3” to not be a shortcut target item. Therefore, the control unit 150 retrieves “samsung2” as a shortcut target item.

Additionally, in order to allow a user or administrator to freely add, delete or adjust desired shortcut target items, an interface capable of adding information about shortcut target items to content may be offered to a user or administrator.

In another embodiment, the type of shortcut target items may be set up by a user, administrator, device manufacturer or software distributor.

For example, in any content written in HTML format, a user may set up an item having the “a” tag or the “input” tag as a shortcut target item. In this case, each item having the “a” tag or the “input” tag among items contained in the content is regarded as a shortcut target item.

In another example, a user may set up, as a shortcut target item, only an item having the “submit” value for the “type” attribute (this item means a query input button) among all items having the “input” tag.

In the example shown in FIG. 2, the display region 220 displays a web page as content. As can be seen, this content involves eight shortcut target items 230a to 230h each of which is a link to a bulletin board. However, a posting message link 240, a log-in input box 245, a log-in button 246 and other items are not set up as a shortcut target item even though they are also displayed in the display region 220.

Depending on the size of the display region 220 or a scrolling operation, parts of or all shortcut target items 230 may be displayed in the display region 220.

When a user clicks on the first item 230a, the first bulletin board is displayed. Namely, the first item 230a is a link to the first bulletin board. Similarly, the other items 230b to 230h are links connected to other boards, respectively. Similarly, items may include various objects allowing a user's operation, such as links, buttons, text areas, etc.

In the first screen view 210a, the display region 220a includes the first item 230a to the eighth item 230h among the shortcut target items 230. If the first screen view 210a is changed to the second screen view 210b in response to a scrolling operation, the first and second items 230a and 230b may disappear from the second screen view 210b.

Particularly, the control unit 150 allots a specific shortcut key to each of the shortcut target items 230 displayed in the display region 220. Thereafter, if a user selects a specific shortcut key, the control unit 150 performs a particular function corresponding to the shortcut target item 230 to which the selected shortcut key is allotted. Namely, a shortcut key is allotted to each of the first shortcut target item 230a to the eighth shortcut target item 230h and, if an input is detected from one of eight shortcut keys, a link of the shortcut target item corresponding to the detected shortcut key is executed.

Returning to FIG. 1, the electronic device 100 for providing a shortcut interface will now be described in detail.

The display unit 180 displays one or more items in the display region. The input unit 120 receives a user's input gesture, such as a touch or press, for selecting a shortcut key. For example, the first screen view 210a shown in FIG. 2 involves eight virtual number keys (1˜8) defined as shortcut keys.

The control unit 150 detects a change of details displayed in the display region 220, retrieves shortcut target items 230 among items displayed in the display region 220, allots a shortcut key to each retrieved shortcut target item 230, receives a user's selection of one of shortcut keys through the input unit 120, and performs a particular function of a specific shortcut target item 230 to which a selected shortcut key is allotted.

Additionally, the control unit 150 may control the display unit 180 so that a shortcut key may be displayed within a given distance from a shortcut target item 230. Namely, the display unit 180 displays a shortcut key for each shortcut target item 230 at a given position under the control of the control unit 150. In FIG. 2, for example, such a shortcut key is displayed as a mark 250 or 251 at the right of each shortcut target item 230. The position of such a mark 250 or 251 may be set up by a user, administrator, device manufacturer or software distributor.

Furthermore, the control unit 150 may control the display unit 180 so that a mark 250 or 251 of a shortcut key may be displayed as an overlay on each shortcut target item 230. Namely, a mark 250 or 251 of a shortcut key may be semi-transparently placed on a shortcut target item 230, thus offering more exact information about a shortcut key to the user without obstructing the view of an underlying shortcut target item 230.

Meanwhile, as discussed above, content may be written in a certain markup language. In this case, the control unit 150 retrieves a predefined tag having the shortcut attribute and then retrieves a shortcut target item 230 rendered in the display region 220 among items corresponding to retrieved tags.

In another embodiment, the control unit 150 may retrieve a predefined zone involved in the display region 220 as a shortcut target item 230. In this case, setting data of content or applications should have information about such zones to be retrieved as a shortcut target item 230. Coordinate values or any other equivalent values may be used for setting data.

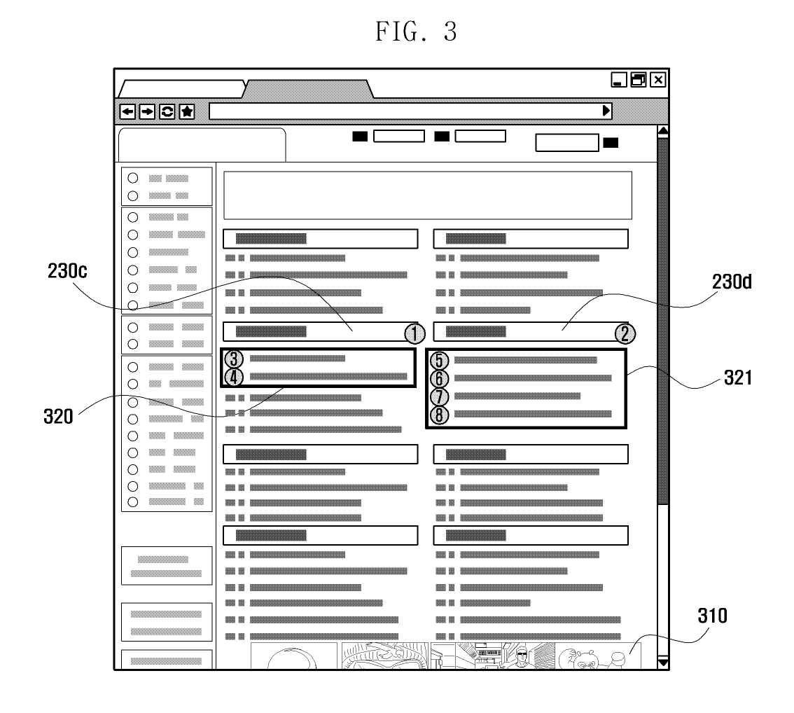

FIG. 3 is a larger view illustrating a screen view on a display unit of an electronic device in accordance with another embodiment of the present invention.

If there are too many shortcut target items to be rendered in the display region, the control unit 150 may selectively allot shortcut keys to target items according to priority.

The above embodiment with regard to FIG. 2 is discussed on the assumption that a bulletin board link 230 only is set up as a shortcut target item. However, this embodiment supposes that both a bulletin board link 230 and a posting message link 240 are set up as shortcut target items and that a bulletin board link 230 has a relatively higher priority. The number of shortcut keys to be allotted is limited to a given value (e.g., eight), and therefore the limited shortcut keys are allotted first to a bulletin board link 230 with a higher priority.

FIG. 3 shows the same screen view as the first screen view 210a in FIG. 2. However, the shortcut keys are differently allotted. Specifically, in FIG. 3, shortcut keys are allotted respectively to the third item 230c which is a link to a “useful site” board, to the fourth item 230d which is a link to a “joint purchase” board, to two items 320 of posting message links in a “useful site” board, and to four items 321 of posting message links in a “joint purchase” board. This allotment scheme is exemplary only and may be varied according to a change in priority. Such priority may be set up by a user or an administrator.

The control unit 150 may retrieve a priority rule which is contained in the content itself or offered as separate data. In the former case, original content may require modification depending on a user's or administrator's setting for priority. Also, any interface may be offered so that a user or administrator can establish a rule of determining priority regarding shortcut target items.

For example, in the case of content written in HTML format, an interface may allow a user to establish a priority rule in which a priority 10 is assigned to the “input” tag and a priority 5 is assigned to the “a” tag. According to such a priority rule, the priority of items defined by the “input” tag such as a text input box, a “submit” button, a radio button or a checkbox is higher than that of link items defined by the “a” tag. Therefore, shortcut keys are allotted first of all to items with an “input” tag and then, if there is any shortcut key left over, allotted to items with an “a” tag. As mentioned above, the number of shortcut keys to be allotted may be limited to a given value (e.g., eight).

In another embodiment, a priority value of each item may be contained in the content. The control unit 150 may retrieve each priority value and then allot a shortcut key according to a retrieved priority value.

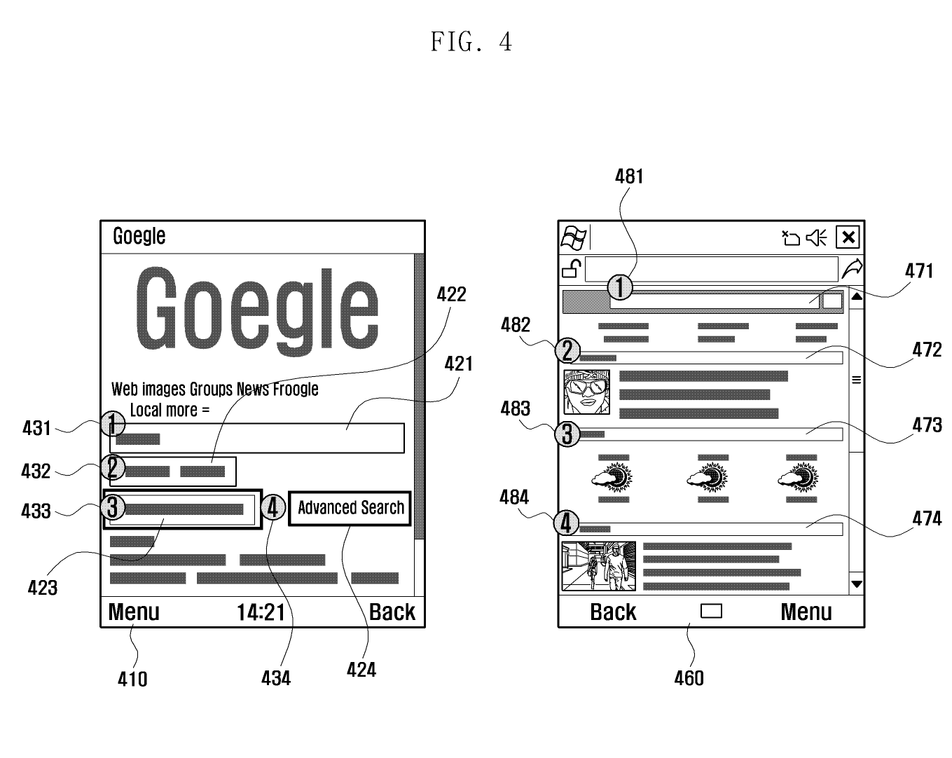

FIG. 4 is a view illustrating a screen view of a mobile web browser in accordance with still another embodiment of the present invention.

Since a mobile web browser is offered on the display unit with a relatively smaller size, it may cause much trouble to select one of the items by means of navigation keys of a keypad or other alternative. Therefore, a mobile web browser really needs a shortcut interface.

Referring to FIG. 4, in the first screen view 410, a shortcut key ‘1’ is allotted to a text input box 421 and represented as the first shortcut mark 431 with an overlay form. Similarly, a shortcut key ‘2’ is allotted to the first submit button 422 and represented as the second shortcut mark 432 with an overlay form. In addition, a shortcut key ‘3’ is allotted to the second submit button 423 and represented as the third shortcut mark 433 with an overlay form, and also a shortcut key ‘4’ is allotted to a link item 424 and represented as the fourth shortcut mark 434 with an overlay form.

In this screen view 410, priority values are assigned in the order of the text input box 421, the first submit button 422, the second submit button 423 and the link item 424, and hence the allotment of shortcut keys follows the above order. Such priority values of respective items may be determined by a user, administrator, etc. and may be contained in the content or separately offered.

If two or more items have the same priority, a shortcut key may be allotted in order from the uppermost or leftmost item in the screen view. Additionally, a detailed order may be set up by a user, administrator, device manufacturer or software distributor.

Meanwhile, in the second screen view 460, a shortcut key ‘1’ is allotted to a text input box 471 and represented as the fifth shortcut mark 481 with an overlay form. Similarly, a shortcut key ‘2’ is allotted to the first link item 472 and represented as the sixth shortcut mark 482 with an overlay form. In addition, a shortcut key ‘3’ is allotted to the second link item 473 and represented as the seventh shortcut mark 483 with an overlay form, and also a shortcut key ‘4’ is allotted to the third link item 474 and represented as the eighth shortcut mark 484 with an overlay form.

In this screen view 460, priority values are assigned in the order of the text input box 471, the first link item 472, the second link item 473 and the third link item 474, and hence the allotment of shortcut keys follows the above order. Such priority values of respective items may be determined by a user, administrator, etc. and may be contained in the content or separately offered.

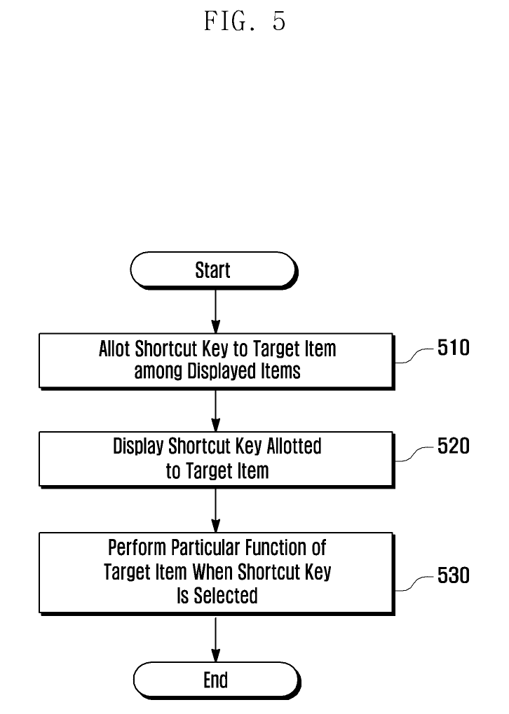

FIG. 5 is a flow chart illustrating a method for providing a shortcut interface in an electronic device in accordance with an embodiment of the present invention.

Referring to FIG. 5, the control unit 150 allots a shortcut key to a shortcut target item among items displayed in a display region, depending on shortcut target item information in step 510.

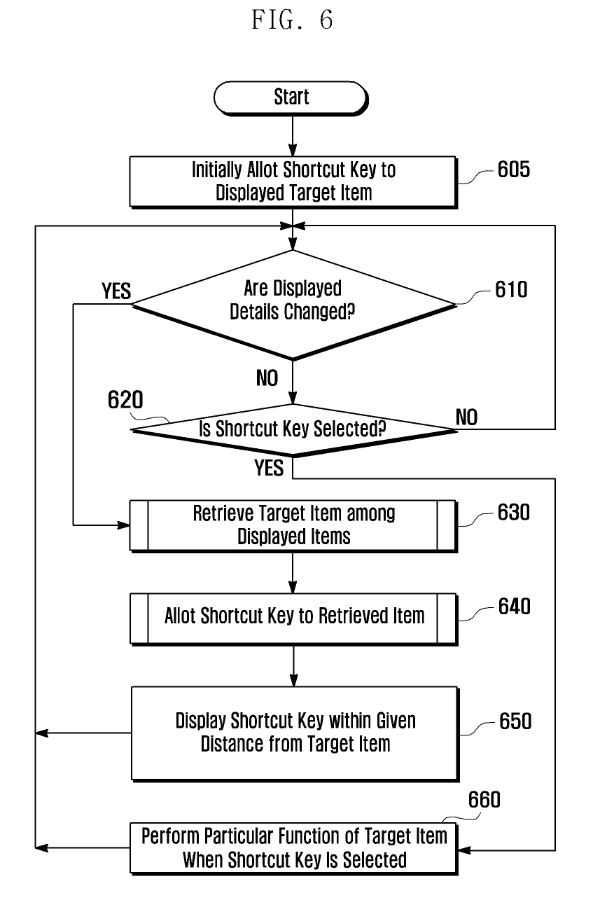

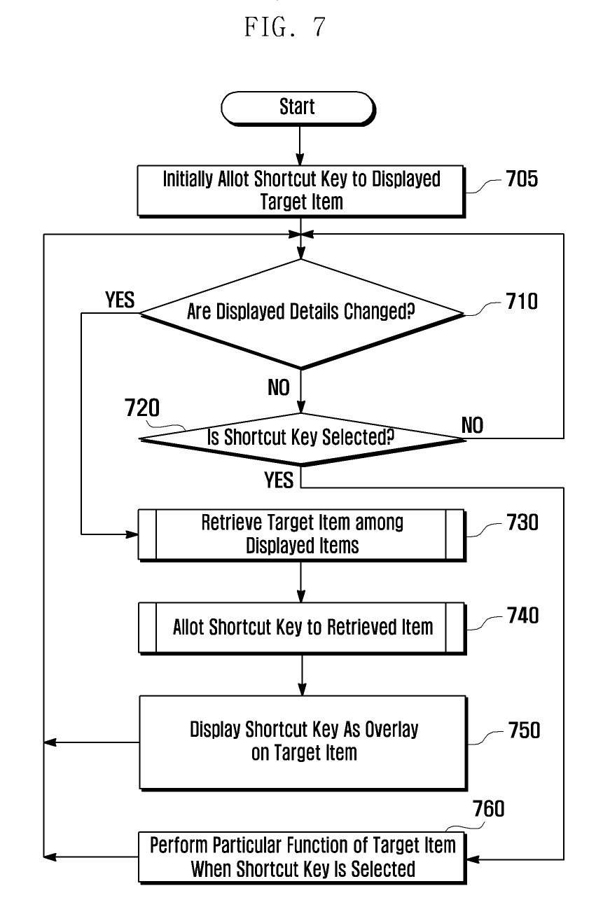

Shortcut target item information refers to details used to distinguish a shortcut target item in items. Such shortcut target item information may be contained in the content or separately offered. In particular, shortcut target item information may be offered in the manner of associating predefined tags with shortcut target items or of rendering an identification list of shortcut target items. Additionally, shortcut target item information may be a rule of determining shortcut target items. As an example of such a rule, shortcut target items may be designated by the “a” tag only or a tag only having the “y” value for the “is Shortcut” attribute. Depending on such shortcut target item information, the control unit 150 retrieves a shortcut target item and then allots a shortcut key to a retrieved shortcut target item. This process will be described below with reference to steps 630 and 640 of FIG. 6, and steps 730 and 740 of FIG. 7.

The control unit 150 may periodically allot a shortcut key to a shortcut target item or alternatively may again allot a shortcut key to a shortcut target item when detecting a change in a display view caused by a line scrolling or a page turning over. The latter case will be described below with reference to FIGS. 6 and 7.

Additionally, the control unit 150 controls the display unit 180 so that a shortcut key allotted to a shortcut target item 230 can be displayed as a suitable mark 250 in step 520. Namely, the display unit 180 displays the mark 250 indicating a shortcut key under the control of the control unit 150.

Preferably, the shortcut key mark 250 is required to inform a user that there is a shortcut key. In one embodiment, the shortcut key mark 250 may be displayed within a given distance from a corresponding shortcut target item 230. This case will be described below with reference to FIG. 6. In another embodiment, the shortcut key mark 250 may be displayed in an overlay form on a corresponding shortcut target item 230. This case will be described below with reference to FIG. 7.

Next, the control unit 150 receives a user's selection of a specific shortcut key through the input unit and then performs a particular function of a shortcut target item to which a selected shortcut key is allotted in step 530.

For example, if a shortcut key ‘1’ allotted to the first item 230a is selected through the input unit 120, a function assigned to the first item 230a is performed. Namely, depending on link information in the first item 230a, the first bulletin board is displayed.

The input unit 120 may be a typical input device based on a button type such as a keypad or keyboard. The input unit 120 may allow a user to easily use a desired function through a shortcut key selection.

FIG. 6 is a flow chart illustrating a method for providing a shortcut interface in an electronic device in accordance with another embodiment of the present invention.

Briefly, a shortcut key is initially allotted to a displayed target item in step 605. When a change of details displayed in the display region is detected in step 610, the control unit retrieves a shortcut target item displayed in the display region in step 630 and allots a shortcut key to a retrieved item in step 640. Then a shortcut key is displayed within a given distance from a corresponding shortcut target item in step 650. If a change of details is not displayed in step 610, and a selection of a specific shortcut key is detected in step 620, the control unit performs a particular function of a specific shortcut target item to which a selected shortcut key is allotted in step 660.

In step 605, the control unit 150 initially allots shortcut keys to respective shortcut target items displayed in the display region, so that details initially displayed in the display region become the target of shortcut key allotments. This step of allotting shortcut keys to shortcut target items will be described below in detail with reference to steps 630 and 640. An initial display may be considered to be similar to a change in display, so both cases may be treated equally.

Particularly, in step 610, the control unit 150 determines whether a change of details displayed in the display region 220 is detected. If a display change is detected, the control unit 150 performs the step 630. If no change is detected, the control unit 150 performs the step 620. A change of details displayed in the display region 220 may be caused by a specific event such as a page turning over, a link selection, a line scroll, etc. In particular, even a case of a line scroll with no change of content is considered as a change of details displayed in the display region 220. The reason is that shortcut keys are allotted to display details in a screen view.

Content displayed in the display region may be written by means of a markup language format such as HTML or XML. Alternatively, such contents may be expressed in any other suitable format capable of representing the arrangement of items such as links, images and input boxes.

Display details are particulars actually contained in the display region. Namely, parts disappearing from the display region by a scroll or zoom-in are not considered as display details.

In step 630, the control unit 150 retrieves shortcut target items from all items displayed in the display region, depending on the changed details.

Additionally, in order to allow a user or administrator to freely add, delete or adjust desired shortcut target items, an interface capable of adding information about shortcut target items to content may be offered to a user or administrator. Through such an interface, the control unit 150 may retrieve specific items, actually displayed in the display region, from shortcut target items.

Since a process of retrieving shortcut target items has been discussed above with reference to FIGS. 1 and 2, a detailed description will be omitted herein.

In step 640, the control unit 150 allots a shortcut key to a retrieved shortcut target item.

It is noted that before display details are changed, the control unit allots shortcut keys 1 to 8 to the first to eighth items 230a to 230h of FIG. 2, respectively. Such information on shortcut keys becomes useless as screen view is changed, and therefore is updated with information on newly allotted shortcut keys. Herein, the repetition of the same as described with reference to FIGS. 1 and 2 will be avoided.

In step 650, the control unit 150 controls the display unit 180 so that a shortcut key allotted to each shortcut target item can be displayed within a given distance (e.g., within 10 pixels) from the shortcut target item as shortcut key marks 250 and 251 in FIG. 2, and the position of such marks 250 and 251 may be set up by a user, administrator, device manufacturer or software distributor.

In step 620, the control unit 150 determines whether a certain shortcut key is selected through the input unit 120. Here, a shortcut key is one of shortcut keys allotted in the aforesaid step 605 or 640.

For example, in the first screen view 210a in FIG. 2, shortcut keys 1 to 8 are allotted. When a user selects one of them, the control unit 150 detects a selection of a specific shortcut key and then performs step 660. If there is no selection, the control unit returns to step 610.

In step 660, the control unit 150 performs a particular function of a specific shortcut target item to which a selected shortcut key is allotted.

For example, in the first screen view 210a in FIG. 2, when shortcut key 3 is selected, the control unit 150 performs a function of the third item 230c to which shortcut key 3 is allotted. A particular function of each item may be set up by a user, administrator, device manufacturer or software distributor. In the above example, the third item 230c is one of link items. Therefore, when shortcut key 3 is selected, the control unit 150 displays a new page through a link defined in the third item 230c as if a user clicks on the third item 230c.

A particular function performed by a selection of a shortcut key may be a given function normally executable through a shortcut target item. For example, a function of a link item may be to move to a linked page designated for the link item. Additionally, a function of a radio button item may be to select the radio button. A function of a script item may be to execute a corresponding script. A function of a button item may be to execute a given operation designated for a click on the button item. A function of a text input box may be to enter a state of inputting text into a text input box, namely, to place a cursor in the text input box. A function of an image item may be to save and/or copy an image.

The above discussed functions of respective items are only given as examples and may be differently defined by a user, administrator, device manufacturer or software distributor.

FIG. 7 is a flow chart illustrating a method for providing a shortcut interface in an electronic device in accordance with still another embodiment of the present invention.

Referring to FIG. 7, step 705 corresponds to the aforesaid step 605 in FIG. 6. In addition, steps 710, 720, 730, 740 and 760 in FIG. 7 correspond to the aforesaid steps 610, 620, 630, 760 and 660 in FIG. 6, respectively. Therefore, a description regarding the above steps will be omitted herein.

However, step 750 in FIG. 7 differs from the aforesaid step 650 in FIG. 6.

In step 750, the control unit 150 controls the display unit 180 so that a shortcut key allotted to a shortcut target item can be displayed in the form of overlay on the shortcut target item. Namely, the display unit 180 displays a shortcut key over each corresponding shortcut target item under the control of the control unit 150. Referring to the example of FIG. 2, shortcut key marks 250 and 251 are displayed in the form of overlay on shortcut target items 230 to which shortcut keys are allotted. Namely, shortcut key marks 250 and 251 may be semi-transparently placed on shortcut target items 230. The position and transparency of such marks 250 and 251 may be determined by a user, administrator, device manufacturer or software distributor.

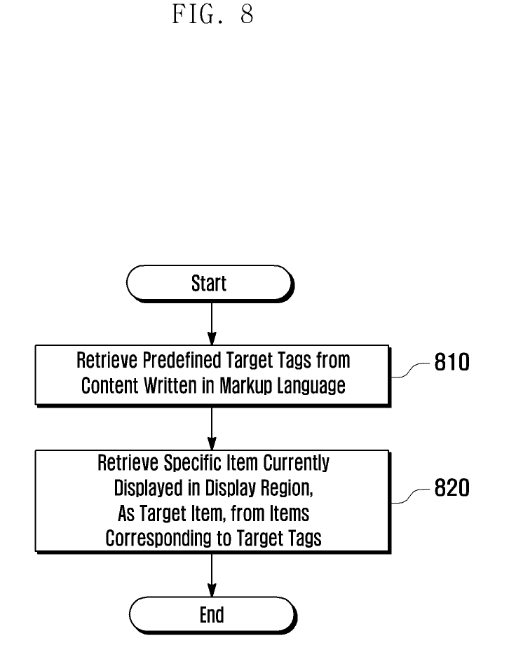

FIG. 8 is a flow chart illustrating in detail a step of retrieving shortcut target items for a shortcut interface in accordance with an embodiment of the present invention. Namely, FIG. 8 shows a detailed process of the aforesaid steps 630 and 730.

In steps 630 and 730, the control unit 150 retrieves shortcut target items from all items displayed in the display region, depending on a change of display details.

The embodiment of FIG. 8 is based on the assumption that content actually displayed in the display region are written in a markup language format such as HTML or XML. Here, objects expressed by the “a” tag (which means a link), the “input” tag (which means a text input box, a button, a checkbox, etc.), the “javascript” tag (which means JavaScript), the “img” tag (which means an image), and the like may be items.

Referring to FIG. 8, the control unit 150 retrieves predefined shortcut target tags from content written in a markup language in step 810.

The following is an example of element written in HTML format and composed of a tag and an item for content to be rendered on the display region.

<a href=“http://www.samsung.com/”>samsung1</a>

As described above in the discussion of FIG. 2, this tag creates a link to “http://www.samsung.com”. Here, if this tag has the “is Shortcut” attribute, the “y” value indicates that an item to be rendered is a shortcut target item, and the “n” value indicates that an item to be rendered is not a shortcut target item.

<a href=“http://www.samsung.com/” isShortcut=“y”>samsung2</a>
<a href=“http://www.samsung.com/” isShortcut=“n”>samsung3</a>

As also described above, when the control unit 150 reads two items “samsung2” and “samsung3” in the content, it interprets “samsung2” as a shortcut target item but considers “samsung3” to be not a shortcut target item. Therefore, the control unit 150 retrieves “samsung2” as a shortcut target item.

Returning to FIG. 8, the control unit 150 retrieves specific items currently displayed in the display region, as shortcut target items, from all items 230 corresponding to shortcut target tags in step 820.

Referring again to FIG. 2, in the display region 220a of the first screen view 210a, eight items 230a to 230h only are displayed among all items 230 corresponding to shortcut target tags. Therefore, these displayed items 230a to 230h only are retrieved as shortcut target items. On the contrary, in the display region 220b of the second screen view 210b, six items 230c to 230h only are displayed and hence retrieved as shortcut target items.

Even though the same content is displayed, currently displayed items only may be retrieved as shortcut target items from all items involved in the content. Then shortcut keys are allotted to such retrieved items only.

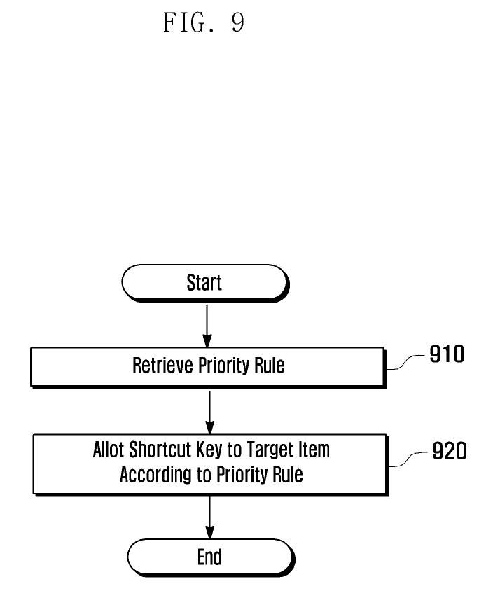

FIG. 9 is a flow chart illustrating in detail a step of allotting a shortcut key to a retrieved item in accordance with an embodiment of the present invention. Namely, FIG. 9 shows a detailed process of the aforesaid steps 640 and 740.

In the steps 640 and 740, the control unit 150 allots shortcut keys to respective shortcut target items retrieved in the previous steps 630 and 730.

The embodiment of FIG. 9 is based on the assumption that a priority rule is offered to the device 100 in the form of being contained in the content or being separate from content.

Referring to FIG. 9, the control unit 150 retrieves a priority rule in step 910.

As discussed above with reference to FIGS. 2 to 4, different priority rules may be applied to the same display view. Therefore, shortcut keys may be allotted depending on different priority rules as shown respectively in the first screen view 210a of FIG. 2 and the screen view 310 of FIG. 3.

A priority rule may be contained in content itself or offered as separate data. In the former case, original contents may require modification depending on a user's or administrator's setting for priority. Also, any interface may be offered so that a user or administrator can establish a rule of determining priority regarding shortcut target items displayed in the display region 220.

For example, in the case of content written in HTML format, an interface may allow a user to establish a priority rule in which a priority 10 is assigned to the “input” tag and a priority 5 is assigned to the “a” tag. According to such a priority rule, the priority of items defined by the “input” tag such as a text input box, a “submit” button, a radio button or a checkbox is higher than that of link items defined by the “a” tag. Therefore, shortcut keys are allotted first of all to items with “input” tag and then, if there is any shortcut key left over, allotted to items with “a” tag. As mentioned above, the number of shortcut keys to be allotted may be limited to a given value (e.g., eight).

The control unit 150 then allots shortcut keys to the target items according to the priority rule in step 920.

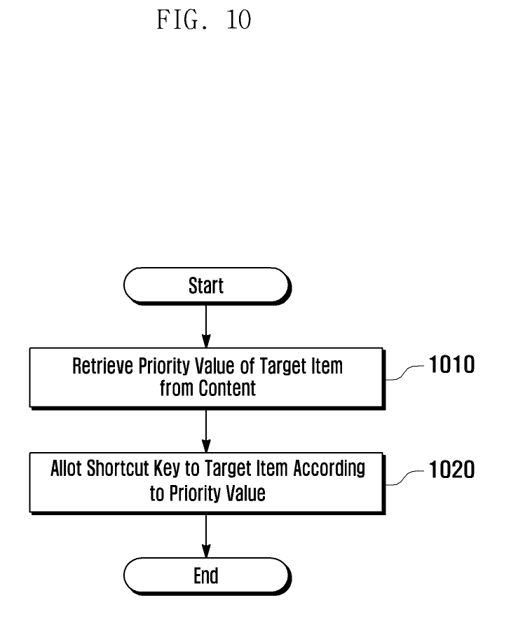

FIG. 10 is a flow chart illustrating in detail a step of allotting a shortcut key to a retrieved item in accordance with another embodiment of the present invention. Namely, FIG. 10 shows another detailed process of the aforesaid steps 640 and 740.

This embodiment in FIG. 10 is based on the assumption that a priority value of each shortcut target item is contained in the content.

Referring to FIG. 10, the control unit 150 retrieves a priority value of each shortcut target item from the content in step 1010.

For example, in any content written in HTML format, the “priority” attribute may be offered as a priority value for a shortcut target tag.

<a href=“http://www.samsung.com/” priority=“10”>samsung2</a>
<a href=“http://www.samsung.com/” priority=“5”>samsung3</a>

Here, the “samsung2” item has a priority value 10, and the “samsung3” item has a priority value 5. If both items are displayed in the display region, a shortcut key is allotted first to the “samsung2” item and then allotted to the “samsung3” item. Since the number of shortcut keys allotted to target items is normally limited, shortcut keys are allotted in order from specific items having relatively higher priority values.

An interface capable of setting up priority values may be offered to a user or administrator. Through such an interface, a user may determine his or her own specialized shortcut interface by selectively designating a priority value for each item.

The control unit 150 then allots shortcut keys to the target items according to the priority value in step 1020.

An electronic device according to the present invention may include, but is not limited to, a mobile phone, a Personal Digital Assistant (PDA), a smart phone, a Portable Multimedia Player (PMP), a music player, a digital broadcasting receiver, a car navigation system, a Personal Computer (PC), a notebook, a laptop computer, an interactive TV, and any other device capable of displaying a user's input on a screen.

While this invention has been particularly shown and described with reference to certain embodiments thereof, it will be understood by those skilled in the art that various changes in form and details may be made therein without departing from the spirit and scope of the invention as defined by the appended claims.

What is claimed is:

1. A method for providing a shortcut interface, the method comprising:
allotting a shortcut key to a shortcut target item among items displayed in a display region, depending on shortcut target item information used to distinguish the shortcut target item in the items;
displaying the shortcut key in the display region; and
when the shortcut key is selected, performing a particular function of the shortcut target item to which the selected shortcut key is allotted.

2. The method of claim 1, wherein allotting the shortcut key is performed when details displayed in the display region have been changed.

3. The method of claim 1, wherein allotting the shortcut key includes:
retrieving the shortcut target item from the items displayed in the display region, depending on the shortcut target item information; and
allotting the shortcut key to the retrieved shortcut target item.

4. The method of claim 3, wherein details displayed in the display region is content written by means of a markup language, and
wherein retrieving the shortcut target item includes:
retrieving predefined shortcut target tags from the content, depending on the shortcut target item information; and
retrieving a specific item currently displayed in the display region, as the shortcut target item, from the items corresponding to the retrieved shortcut target tags.

5. The method of claim 4, wherein the details displayed in the display region is a web page.

6. The method of claim 3, wherein allotting the shortcut key to the retrieved shortcut target item includes:
retrieving a priority rule; and
allotting the shortcut key to the retrieved shortcut target item, depending on the retrieved priority rule.

7. The method of claim 3, wherein content displayed in the display region contains a priority value corresponding to the shortcut target item, and
wherein allotting the shortcut key to the retrieved shortcut target item includes:
retrieving the priority value from the content; and
allotting the shortcut key to the retrieved shortcut target item, depending on the retrieved priority value.

8. The method of claim 1, wherein displaying the shortcut key includes displaying the shortcut key within a given distance from the shortcut target item.

9. The method of claim 1, wherein displaying the shortcut key includes displaying the shortcut key in the form of an overlay on the shortcut target item.

10. The method of claim 1, wherein the shortcut target item is a predefined zone in the display region.

11. An electronic device for providing a shortcut interface, the device comprising:
a display unit configured to display items in a display region;
an input unit configured to receive a selection of a shortcut key; and
a control unit configured to allot the shortcut key to a shortcut target item among the items displayed in the display region, depending on shortcut target item information used to distinguish the shortcut target item in the items, and when the shortcut key is selected through the input unit, to perform a particular function of the shortcut target item to which the selected shortcut key is allotted.

12. The device of claim 11, wherein the control unit is further configured to perform the allotting of the shortcut key when details displayed in the display region have been changed.

13. The device of claim 11, wherein the control unit is further configured to retrieve the shortcut target item from the items displayed in the display region, depending on the shortcut target item information, and to allot the shortcut key to the retrieved shortcut target item.

14. The device of claim 12, wherein the details displayed in the display region is content written by means of a markup language, and
wherein the control unit is further configured to retrieve predefined shortcut target tags from the content, depending on the shortcut target item information, and to retrieve a specific item currently displayed in the display region, as the shortcut target item, from the items corresponding to the retrieved shortcut target tags.

15. The device of claim 14, wherein the details displayed in the display region is a web page.

16. The device of claim 13, wherein the control unit is further configured to retrieve a priority rule, and to allot the shortcut key to the retrieved shortcut target item, depending on the retrieved priority rule.

17. The device of claim 13, wherein content displayed in the display region contains a priority value corresponding to the shortcut target item, and
wherein the control unit is further configured to retrieve the priority value from the content, and to allot the shortcut key to the retrieved shortcut target item, depending on the retrieved priority value.

18. The device of claim 11, wherein the control unit is further configured to control the display unit so that the shortcut key can be displayed within a given distance from the shortcut target item, and
wherein the display unit is further configured to display the shortcut key under the control of the control unit.

19. The device of claim 11, wherein the control unit is further configured to control the display unit so that the shortcut key can be displayed in the form of an overlay on the shortcut target item, and
wherein the display unit is further configured to display the shortcut key under the control of the control unit.

20. The device of claim 11, wherein the shortcut target item is a predefined zone in the display region.
